(19) United States
(12) Patent Application Publication
(10) Pub. No.: US 2024/0077188 A1
(43) Pub. Date: Mar. 7, 2024

(54) LIGHT SOURCE MODULE

(71) Applicant: Qisda Corporation, Taoyuan City (TW)

(72) Inventors: Chih-Shiung CHIEN, Taoyuan City (TW); Ming-Kuen LIN, Taoyuan City (TW); Tsung-Hsun WU, Taoyuan City (TW); Yi-Ling LO, Taoyuan City (TW)

(73) Assignee: Qisda Corporation, Taoyuan City (TW)

(21) Appl. No.: 18/236,907

(22) Filed: Aug. 22, 2023

(30) Foreign Application Priority Data
Sep. 7, 2022 (CN) 202211089568.6

(51) Int. Cl. F21V 13/14; F21V 5/00; F21V 9/20; F21V 9/40

(52) U.S. Cl. CPC F21V 13/14; F21V 5/008; F21V 9/20; F21V 9/40; F21Y 2113/10

(57) ABSTRACT

A light source module includes a first light source and a second light source. The first light source is configured for emitting a first light having a first wavelength, and the first light includes a first part and a second part. The second light source is configured for emitting a second light having a second wavelength. The second light source includes a first wavelength conversion layer, and the first wavelength conversion layer is configured for converting the first light into the second light. One of the first part and the second part is incident to the first wavelength conversion layer, and the other of the first part and the second part is not incident to the first wavelength conversion layer.

This application claims the benefit of People's Republic of China application Serial No. 202211089568.6, filed on Sep. 7, 2022, the subject matter of which is incorporated herein by reference.

### TECHNICAL FIELD

The disclosure relates in general to a light source.

### BACKGROUND

The light source module has a wide application, and many devices need the light source module, such as projectors, illuminator, flashlight, etc. Generally speaking, the greater the luminous brightness of the light source module is, the wider the application range of the light source module and the better the lighting effect is. Therefore, proposing a new light source module capable of providing higher brightness is one of the goals of the industry in this technical field.

### SUMMARY

This disclosure proposes a light source module capable of improving the aforementioned conventional problems.

According to an embodiment of the present invention, a light source module is provided. The light source module includes a first light source and a second light source. The first light source is configured to emit a first light, wherein the first light has a first wavelength, and includes a first part and a second part. The second light source is configured to emit a second light, wherein the second light has a second wavelength and includes a first wavelength conversion layer configured to convert the first light into the second light. One of the first part and the second part is incident to the first wavelength conversion layer, while the other of the first part and the second part is not incident to the first wavelength conversion layer.

Compared with the prior art, in the light source module proposed by the present invention, the first part and the second part of the colored light with the first wavelength emitted by the first light source are respectively converted by the first wavelength conversion layer and the second wavelength conversion layer into the colored light with the second wavelength. The light-splitting of the above-mentioned colored light with the first wavelength could be realized by using the refraction element, so that the second light sources and the third light source of the same color could be disposed adjacent to each other to emit light in the same direction. As a result, it could improve the brightness and uniformity of the part having the second wavelength provided by the light source module. In addition, using of the dichroic beam splitters for the second light sources and the third light source of the same color respectively, so that the light traveling through the wavelength conversion region multiple times for exciting more light of the second wavelength, and further enhance the brightness of the part having the second wavelength.

The above and other aspects of the disclosure will become better understood with regard to the following detailed description of the preferred but non-limiting embodiment(s). The following description is made with reference to the accompanying drawings.

### BRIEF DESCRIPTION OF THE DRAWINGS

FIG. 1 shows a schematic diagram of an optical path of a light source module according to an embodiment of the present invention; and

FIG. 2 shows a schematic diagram of an optical path of a light source module according to another embodiment of the present invention.

### DETAILED DESCRIPTION

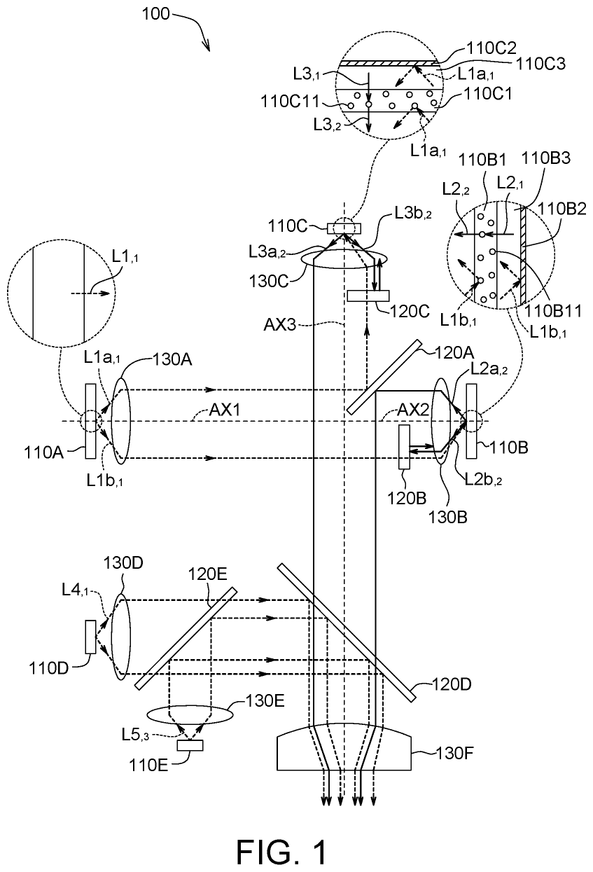

Referring to FIG. 1, FIG. 1 shows a schematic diagram of an optical path of a light source module 100 according to an embodiment of the present invention. The light source module 100 could be applied to a device which needs a light source, for example, a projector, illuminator, display or other types of devices. For application in a projection device, the light source module 100 could also be called a light combining module.

As shown in FIG. 1, the light source module 100 includes a first light source 110A, a second light source 110B, a third light source 110C, a fourth light source 110D, a fifth light source 110E, a first refraction element 120A, and a first light-splitting element 120B, a second light-splitting element 120C, a third light-splitting element 120D, a fourth light-splitting element 120E and at least one condenser lens (for example, a first condenser lens 130A, a second condenser lens 130B, a third condenser lens 130C, a fourth condenser lens 130D, a fifth condenser lens 130E and/or a sixth condenser lens 130F).

As shown in FIG. 1, the first light source 110A is configured to emit a first light L1_{,1} (subscript “1” means “the first wavelength”), the first light L1_{,1} has a first wavelength, and the first light L1_{,1} includes a first portion L1a_{,1} and a second portion L1b_{,1}. The second light source 110B is configured to emit the second light L2_{,2} (the subscript “2” means “the second wavelength”), and the second light L2_{,2} has the second wavelength. The second light source 110B includes a first wavelength conversion layer 110B1 for converting the first light L1_{,1} into the second light L2_{,2}. One of the first part L1a_{,1} and the second part L1b_{,1} is incident to the first wavelength conversion layer 110B1, while another (or the other) of the first part L1a_{,1} and the second part L1b_{,1} is not incident to the first wavelength conversion layer 110B1. As a result, the first light incident to the first wavelength conversion layer 110B1 could be converted into the second light, thereby increasing the brightness of the second light.

In an embodiment, the second light is, for example, green light. Green light accounts for about 70% of white light, and the higher the proportion of green light is, the higher the brightness of white light is. Since the light source module 100 provides the green light (the first light incident to the first wavelength conversion layer 110B1 is converted into green light) with a high light-flux/a high brightness, the brightness of the white light emitted by the light source module 100 could be enhanced. In an embodiment, the first wavelength is smaller than the second wavelength, and thus the light of the first wavelength could be efficiently excited to generate the light of the second wavelength. In an embodiment, the first light is, for example, blue light. For converting into green light, blue light has a higher wavelength conversion efficiency (in comparison with other colors of longer wavelength), and thus it could be converted into stronger green light (in comparison with the light of other color).

As shown in FIG. 1, the first part L1a_{,1} and the second part L1b_{,1} could travel along opposite two sides of the first axis AX1 respectively, wherein the first axis AX1 passes through the first light source 110A. For example, the first axis AX1 coincides with an optical axis of the light source 110A. The first light source 110A itself may not include a wavelength conversion layer, and thus the light emitted by its light-emitting layer is an output light of the first light source 110A, that is, the first light L1_{,1}.

As shown in FIG. 1, the second light source 110B further includes a first reflective layer 110B2 and a first light-emitting layer 110B3. The first light-emitting layer 110B3 is formed between the first wavelength conversion layer 110B1 and the first reflective layer 110B2, and the first wavelength conversion layer 110B1 is closer to the first light source 110A than the first reflective layer 110B2. The first light-emitting layer 110B3, for example, includes at least one semiconductor epitaxial layer which could emit a light L2_{,1}. In the present embodiment, the light L2_{,1} is light of the first wavelength, for example. The first wavelength conversion layer 110B1 includes a plurality of fluorescent particles 110B11 which could excite light to convert the wavelength of the light. For example, the light L2_{,1} of the first wavelength is converted into the second light L2_{,2} of the second wavelength. The first reflective layer 110B2 could reflect the light back to the first wavelength conversion layer 110B1 for increasing the wavelength conversion efficiency. In the present embodiment, the first reflective layer 110B2 could reflect the second portion L1b_{,1} back to the first wavelength conversion layer 110B1.

In the present embodiment, the first wavelength conversion layer 110B1 is a sub-component of the second light source 110B. In another embodiment, the first wavelength conversion layer 110B1 could be disposed independently of the second light source 110B. For example, the first wavelength conversion layer 110B1 and the first light-emitting layer 110B3 are separately disposed.

As shown in FIG. 1, the second light L2_{,2} emitted by the second light source 110B includes a third portion L2a_{,2} and a fourth portion L2b_{,2}. The third part L2a_{,2} and the fourth part L2b_{,2} could travel along opposite two sides of the second axis AX2, wherein the second axis AX2 passes through the second light source 110B. For example, the second axis AX2 coincides with an optical axis of the second light source 110B. In an embodiment, the first axis AX1 and the second axis AX2 could coincide, but they also could be staggered.

As shown in FIG. 1, the third light source 110C could emit a third light L3_{,2} of, for example, a second wavelength. The third light source 110C includes a second wavelength conversion layer 110C1, a second reflective layer 110C2 and a second light-emitting layer 110C3. The second light-emitting layer 110C3 is formed between the second wavelength conversion layer 110C1 and the second reflective layer 110C2, and the second wavelength conversion layer 110C1 is closer to the first refraction element 120A than the second reflective layer 110C2. The second light-emitting layer 110C3, for example, includes at least one semiconductor epitaxial layer which could emit a light L3_{,1}. The second wavelength conversion layer 110C1 could convert the light of the first wavelength into the light of the second wavelength. For example, the second wavelength conversion layer 110C1 could convert the light L3_{,1} of the first wavelength into the third light L3_{,2} of the second wavelength. The second wavelength conversion layer 110C1 includes a plurality of fluorescent particles 110C11 which could excite light to convert the wavelength of the light. The second reflective layer 110C2 could reflect the light back to the second wavelength conversion layer 110C1 for increasing the probability of the light being excited. In the present embodiment, the second reflective layer 110C2 could reflect the first portion L1a_{,1} back to the second wavelength conversion layer 110C1.

In the present embodiment, the second wavelength conversion layer 110C1 is a sub-element of the third light source 110C. In another embodiment, the second wavelength conversion layer 110C1 could be disposed independently of the third light source 110C. For example, the second wavelength conversion layer 110C1 and the second light-emitting layer 110C3 could be separately disposed.

As shown in FIG. 1, the third light L3_{,2} emitted by the third light source 110C includes a fifth portion L3a_{,2} and a sixth portion L3b_{,2}. The fifth part L3a_{,2} and the sixth part L3b_{,2} could travel along opposite two sides of the third axis AX3, wherein the third axis AX3 passes through the third light source 110C. For example, the third axis AX3 coincides with an optical axis of the third light source 110C. In an embodiment, the third axis AX3 is substantially perpendicular to the second axis AX2 (or the first axis AX1).

As shown in FIG. 1, the fourth light source 110D could emit fourth light L4_{,1} of, for example, the first wavelength. The fourth light source 110D itself may not include a wavelength conversion layer, and thus the light emitted by its light-emitting layer is an output light of the fourth light source 110D, that is, the fourth light L4_{,1}.

As shown in FIG. 1, the fifth light source 110E could emit a fifth light L5_{,3} of, for example, a third wavelength. The fifth light source 110E itself may not include a wavelength conversion layer, and thus the light emitted by its light-emitting layer is an output light of the fifth light source 110E, that is, the fifth light L5_{,3}.

Light of different wavelengths has different light colors. In terms of light color, the aforesaid colored light of the first wavelength is, for example, blue light (for example, the wavelength ranges between 450 nanometer (nm) and 495 nm), red light (for example, the wavelength ranges between 620 nm and 750 nm) and green light (for example, the wavelength ranges, for example, one of 495 nm to 570 nm), the colored light of the second wavelength is, for example, another of blue light, red light and green light, and the colored light of the third wavelength is, for example, the other of blue light, red light and blue light. In the present embodiment of the present invention, the colored light of the first wavelength is illustrated by taking blue light as an example, the colored light of the second wavelength is taken as green light, and the colored light of the third wavelength is taken as red light as an example. In another embodiment, the light of the first wavelength may be ultraviolet light (the wavelength range, for example, between 380 nm and 450 nm).

As shown in FIG. 1, the first refraction element 120A is disposed opposite to the first light source 110A, and could reflect the first part L1a_{,1} to the second wavelength conversion layer 110C1. For example, the first refraction element 120A is located at a side of the first axis AX1, so that the first portion L1a_{,1} could be incident to the first refraction element 120A, and be reflected by the first refraction element 120A to the second wavelength conversion layer 110C1. The second portion L1b_{,1} could be incident to the first wavelength conversion layer 110B1 on another side of the first axis AX1 (not blocked by the first refraction element 120A). In addition, the first refraction element 120A is disposed opposite to the second light source 110B and could reflect the third part L2a_{,2} of the second light L2_{,2}. For example, the first refraction element 120A is located at a side of the second axis AX2 to reflect the third portion L2a_{,2}. For example, the first refraction element 120A reflects the third portion L2a_{,2} to the third light-splitting element 120D. As described above, the first refraction element 120A could reflect the light of the first wavelength and the light of the second wavelength. Furthermore, the first refraction element 120A is, for example, a reflective mirror, but it could also be a dichroic beam splitter, or the first refraction element 120A has a transmittance less than 100% for allowing a part of the same one beam of light to pass through while another part of the beam of light is reflected.

As shown in FIG. 1, the first light-splitting element 120B could reflect the light of the second wavelength, but allow the light of the first wavelength to travel through. Furthermore, the first light-splitting element 120B is, for example, a dichroic beam splitter. The first light-splitting element 120B is disposed opposite to the second light source 110B and located at a side of the second axis AX2 to reflect the fourth portion L2b_{,2} back to the first wavelength conversion layer 110B1. In addition, the first light-splitting element 120B allows the second portion L1b_{,1} to travel through, so that the second portion L1b_{,1} could travel through the first light-splitting element 120B to the second light source 110B.

As shown in FIG. 1, the first refraction element 120A and the first light-splitting element 120B are respectively located at opposite two sides of the second axis AX2, wherein the third part L2a_{,2} and the fourth part L2b_{,2} of the second light L2_{,2} are respectively Incident to the first refraction element 120A and the first light-splitting element 120B. In addition, the first refraction element 120A, the first light-splitting element 120B and the second light source 110B are located at a side of the third axis AX3, and the first light source 110A is located at another side of the third axis AX3.

As shown in FIG. 1, the second light-splitting element 120C could reflect the light of the second wavelength, but allow the light of the first wavelength to travel through. Furthermore, the second light-splitting element 120C is, for example, a dichroic beam splitter. The second light-splitting element 120C is disposed opposite to the third light source 110C and is located at a side of the third axis AX1 to reflect the sixth part L3b_{,2} of the third light L3_{,2} back to the third light source 110C. In addition, the second light-splitting element 120C allows the first portion L1a_{,1} to travel through, so that the first portion L1a_{,1} reflected from the first refraction element 120A could travel through the second light-splitting element 120C and be incident to the second light source 110B.

As shown in FIG. 1, the third light-splitting element 120D could reflect the light of the first wavelength and the third wavelength, but allow the light of the second wavelength to travel through. Furthermore, the third light-splitting element 120D is, for example, a dichroic beam splitter. The third light-splitting element 120D is disposed opposite to the fourth light source 110D to reflect the fourth light L4_{,1} emitted by the fourth light source 110D, and the third light-splitting element 120D allows the fifth part L3a_{,2} of the third light L3_{,2} and the third part L2a_{,2} of the second light L2_{,2} to travel through. In addition, the third light-splitting element 120D could reflect the fifth light L5_{,3}.

As shown in FIG. 1, the fourth light-splitting element 120E could reflect the light of the third wavelength, but allow the light of the first wavelength to travel through. Furthermore, the fourth light-splitting element 120E is, for example, a dichroic beam splitter. The fourth light-splitting element 120E is disposed opposite to the fourth light source 110D and the third light-splitting element 120D, so as to allow the fourth light L4_{,1} to travel through the fourth light-splitting element 120E to the third light-splitting element 120D. In addition, the fourth light-splitting element 120E is disposed opposite to the fifth light source 110E, so that the fifth light L5_{,3} is incident to the fourth light-splitting element 120E, and is reflected by the fourth light-splitting element 120E to the third light-splitting element 120D. In other embodiments, the fourth light-splitting element 120E also could reflect the light of the first wavelength, but allow the light of the third wavelength to travel through, and it will not be repeated here.

As shown in FIG. 1, the first light source 110A, the fourth light-splitting element 120E, the fourth light source 110D and the fifth light source 110E are located at a side of the third axis AX3, while the second light source 110B, the first refraction element 120A, the first light-splitting element 120B and the second light-splitting element 120C are located at another side of the third axis AX3.

The condenser lens could condense the light emitted by the light source, so that the light traveling through the condenser lens becomes a collimated light. The condenser lens includes at least one lens which could be a spherical lens, an aspheric lens or a combination thereof.

As shown in FIG. 1, the first condenser lens 130A is disposed opposite to the first light source 110A. The first condenser lens 130A is disposed along the first axis AX1. For example, the first axis AX1 passes through a center of the first condenser lens 130A, so that the first part L1a_{,1} and the second part L1b_{,1} incident to the first condenser lens 130A have the substantial same flux of light relative to the first axis AX1.

As shown in FIG. 1, the second condenser lens 1308 is disposed opposite to the second light source 110B. The second condenser lens 130B is disposed in the second axis AX2. For example, the second axis AX2 passes through a center of the second condenser lens 130B, so that the third part L2a_{,2} and the fourth part L2b_{,2} which are incident to the second condenser lens 1308 have the substantial same flux of light relative to the second axis AX2.

As shown in FIG. 1, the third condenser lens 130C is disposed opposite to the third light source 110C. The third condenser lens 130C is disposed in the third axis AX3. For example, the third axis AX3 passes through a center of the third condenser lens 130C, so that the fifth part L3a_{,2} and the sixth part L3b_{,2} which are incident to the third condenser lens 130C have the substantial same flux of light relative to the third axis AX3.

As shown in FIG. 1, the fourth condenser lens 130D is disposed opposite to the fourth light source 110D, and the fourth light L4_{,1} emitted by the fourth light source 110D travels through the fourth condenser lens 130D and becomes collimated light. The fifth condenser lens 130E is disposed opposite to the fifth light source 110E, and the fifth light L5_{,3} emitted by the fifth light source 110E travels through the fifth condenser lens 130E and becomes collimated light. The sixth condenser lens 130F is disposed opposite to the third light-splitting element 120D, and the light reflected and/or transmitted from the third light-splitting element 120D could travel through the sixth condenser lens 130F to emit, wherein the light is mixed light of at least two of the light of the first wavelength, the light of the second wavelength and the light of the third wavelength.

As shown in FIG. 1, for the first light L1_{,1}, the second light L2_{,2} and the third light L3_{,2}, due to only part of the first light L1_{,1}, only part of the third light L3_{,2} and only part of the second light L2_{,2} being incident to the sixth condenser lens 130F, the required optical channel is not large, so the selected the sixth condenser lens 130F with small optical channel (small size) is enough.

In the present embodiment, the light source module 100 could provide white light. In other embodiments, the light source module 100 could provide colored light other than white light, for example, one of blue light, green light and red light, or a mixed light of blue light, green light and red light. In this example, the light source module 100 could omit components such as the fourth light source 110D, the fifth light source 110E, the third light-splitting element 120D, the fourth light-splitting element 120E, the fourth condenser lens 130D and the fifth condenser lens 130E.

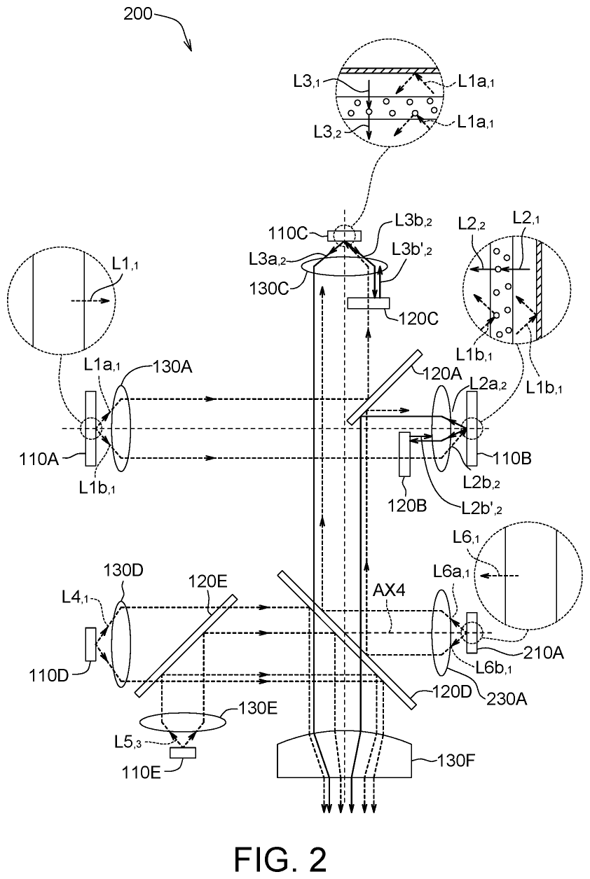

Referring to FIG. 2, FIG. 2 shows a schematic diagram of an optical path of a light source module 200 according to another embodiment of the present invention. The light source module 200 could be applied to a device which needs a light source, for example, a projector, illuminator, display or other types of devices. For application in a projection device, the light source module 200 could also be called a light combining module.

As shown in FIG. 2, the light source module 200 includes the first light source 110A, the second light source 110B, the third light source 110C, the fourth light source 110D, the fifth light source 110E, a sixth light source 210A, the first refraction element 120A, The first light-splitting element 120B, the second light-splitting element 120C, the third light-splitting element 120D, the fourth light-splitting element 120E and at least one condenser mirror (for example, the first condenser mirror 130A, the second condenser mirror 130B, the third condenser mirror 130C, the fourth condenser mirror 130D, the fifth condenser lens 130E, the sixth condenser lens 130F and/or a seventh condenser lens 230A).

The light source module 200 of the embodiment of the present invention has the technical features the same as or similar to that of the light source module 100, and the difference is that the light source module 200 further includes the sixth light source 210A and the seventh condenser lens 230A.

As shown in FIG. 2, the sixth light source 210A could emit a sixth light L6_{,1} of the first wavelength. The sixth light L6_{,1} includes two parts, wherein one of the two parts is incident to the first wavelength conversion layer 110B1, and the other of the two parts is not incident to the first wavelength conversion layer 110B1. For example, the sixth light L6_{,1} includes a seventh part L6a_{,1} and an eighth part L6b_{,1}, wherein the seventh part L6a_{,1} is not incident to the first wavelength conversion layer 110B1, but the eighth part L6b_{,1} is incident to the first wavelength conversion layer 110B1.

As shown in FIG. 2, the first refraction element 120A and the sixth light source 210A are located at the same side of the third axis AX3, so that the eighth part L6b_{,1} of the sixth light L6_{,1} could be incident to the first refraction element 120A along the same side of the third axis AX3, and is reflected from the first refraction element 120A to the second light source 110B. The eighth part L6b_{,1} incident to the second light source 110B has an optical path similar to or the same as that of the second part L1b_{,1}, and it will not be repeated here. The seventh part L6a_{,1} of the sixth light L6_{,1} could be incident to the third light source 110C along another side of the third axis AX3. The seventh part L6a_{,1} incident to the third light source 110C and the eighth part L6b_{,1} incident to the second light source 110B could be converted into colored light of the second wavelength (the optical path is the same as shown in FIG. 1 and its description). As a result, the brightness of the colored light of the second wavelength could be improved, and the brightness of the mixed light (for example, white light) traveling through the sixth condenser lens 130F could be further improved.

As shown in FIG. 2, the seventh part L6a_{,1} and the eighth part L6b_{,1} could travel along opposite two sides of the fourth axis AX4 respectively, wherein the fourth axis AX4 passes through the sixth light source 210A. For example, the fourth axis AX4 coincides with an optical axis of the sixth light source 210A. The sixth light source 210A itself may not include a wavelength conversion layer, so the light emitted by its light-emitting layer is an output light of the sixth light source 210A, that is, the sixth light L6_{,1}.

As shown in FIG. 2, the third light-splitting element 120D is disposed opposite to the second wavelength conversion layer 110C1 and the sixth light source 210A for reflecting the seventh part L6a_{,1} and the eighth part L6b_{,1}. For example, the third light-splitting element 120D reflects the eighth portion L6b_{,1} to the first wavelength conversion layer 110B1, and reflects the seventh portion L6a_{,1} to the second wavelength conversion layer 110C1.

As shown in FIG. 2, the seventh condenser lens 230A is disposed opposite to the sixth light source 210A, and the sixth light L6_{,1} emitted by the sixth light source 210A travels through the seventh condenser lens 230A and becomes collimated light.

In the present embodiment, the light source module 200 could provide white light. In other embodiments, the light source module 200 could provide colored light other than white light, for example, one of blue light, green light and red light, or a mixed light of blue light, green light and red light. In this example, the light source module 200 could omit components, for example, the fourth light source 110D, the fifth light source 110E, the fourth light-splitting element 120E, the fourth condenser lens 130D and the fifth condenser lens 130E.

To sum up, the embodiment of this disclosure proposes the light source module including the first light source and the second light source, wherein the first light source could emit colored light of the first wavelength, and the second light source could emit colored light of the second wavelength. A part or at least a part of the colored light of the first wavelength emitted by the first light source could be converted into colored light of the second wavelength by a wavelength conversion layer. As a result, it could improve the brightness of the colored light of the second wavelength provided by the light source module. In an embodiment, the aforementioned wavelength conversion layer could be located in the second light source, or disposed independently of the second light source. In addition, using of the dichroic beam splitters for the second light sources and the third light source of the same color respectively, so that the light traveling through the wavelength conversion region multiple times for exciting more light of the second wavelength, and further enhance the brightness of the part having the second wavelength.

It will be apparent to those skilled in the art that various modifications and variations could be made to the disclosed embodiments. It is intended that the specification and examples be considered as exemplary only, with a true scope of the disclosure being indicated by the following claims and their equivalents.

What is claimed is:

1. A light source module, comprising:
a first light source configured to emit a first light, wherein the first light has a first wavelength, and comprises a first part and a second part; and
a second light source configured to emit a second light, wherein the second light has a second wavelength, and the second light source comprises a first wavelength conversion layer configured to convert the first light into the second light;
wherein one of the first part and the second part is incident to the first wavelength conversion layer, while the other of the first part and the second part is not incident to the first wavelength conversion layer.

2. The light source module as claimed in claim 1, wherein the second part is incident to the first wavelength conversion layer, and the light source module further comprises:
a first refraction element disposed opposite to the first light source and configured to reflect the first part.

3. The light source module as claimed in claim 2, further comprising:
a second wavelength conversion layer disposed opposite to the first refraction element and configured to convert a light of the first wavelength into a light of the second wavelength;
wherein the first refraction element is configured to reflect the first part to the second wavelength conversion layer.

4. The light source module as claimed in claim 2, wherein the first refraction element is disposed opposite to the second light source and configured to reflect a part of the second light.

5. The light source module as claimed in claim 2, wherein an axis passes through the first light source, and the first refraction element is located at a side of the axis.

6. The light source module as claimed in claim 1, further comprising:
a first light-splitting element disposed opposite to the first light source and the second light source, and configured to reflect a part of the second light back to the second light source and allow the second part of the first wavelength to travel through.

7. The light source module as claimed in claim 1, wherein the second part is incident to the first wavelength conversion layer, the second light comprises a third part and a fourth part, and the light source module is further comprises:
a first refraction element disposed opposite to the first light source and the second light source and configured to reflect the first part and the third part; and
a first light-splitting element disposed opposite to the second light source and configured to reflect the fourth part back to the first wavelength conversion layer.

8. The light source module as claimed in claim 1, further comprising:
a third light source configured to emit a third light, wherein the third light has the second wavelength, the third light source comprises a second wavelength conversion layer configured to convert a light of the first wavelength converting light into a light of the second wavelength;
wherein the other of the first part and the second part is incident to the second wavelength conversion layer.

9. The light source module as claimed in claim 8, further comprising:
a first refraction element disposed opposite to the first light source and the third light source and configured to reflect the first part to the second wavelength conversion layer.

10. The light source module as claimed in claim 9, wherein an axis passes through the third light source, and the first refracting member is located at a side of the axis.

11. The light source module as claimed in claim 8, further comprising:
a second light-splitting element disposed opposite to the third light source and configured to reflect a part of the third light back to the third light source.

12. The light source module as claimed in claim 11, wherein an axis passes through the third light source, and the second light-splitting element is located at a side of the axis.

13. The light source module as claimed in claim 8, wherein the first part is incident to the second wavelength conversion layer; the light source module further comprises:
a first refraction element disposed opposite to the first light source and the third light source and configured to reflect the first part to the second wavelength conversion layer; and
a second light-splitting element disposed opposite to the third light source and configured to reflect a part of the third light back to the second wavelength conversion layer.

14. The light source module as claimed in claim 13, wherein an axis passes through the third light source, and the first refraction element, the second light-splitting element and the second light source are located at a side of the axis.

15. The light source module as claimed in claim 1, further comprising:
a third light-splitting element configured to reflect a light of the first wavelength; and
a fourth light source disposed opposite to the third light-splitting element and configured to emit a fourth light to be incident to the third light-splitting element, wherein the fourth light has the first wavelength.

16. The light source module as claimed in claim 15, further comprising:
a fourth light-splitting element disposed opposite to the third light-splitting element and configured to reflect a light of a third wavelength;
a fifth light source disposed opposite to the third light-splitting element, and configured to emit a fifth light to be incident to the fourth light-splitting element, wherein the fifth light has the third wavelength;
wherein the third light-splitting element and the fourth light-splitting element are disposed opposite to each other, and the third light-splitting element is configured to reflect a light of the third wavelength.

17. The light source module as claimed in claim 16, wherein an axis passes through the second light source and the third light-splitting element, and the fourth light source, the fifth light source and the fourth light-splitting element are located at a side of the axis.

18. The light source module as claimed in claim 1, further comprising:
a sixth light source configured to emit a sixth light of the first wavelength, wherein the sixth light comprises two parts, one of the two parts is incident to the first wavelength conversion layer, but the other of the two parts is not incident to the first wavelength conversion layer.

19. The light source module as claimed in claim 18, further comprising:
a second wavelength conversion layer configured to convert a light of the first wavelength into a light of the second wavelength; and
a third light-splitting element disposed opposite to the second wavelength conversion layer and the sixth light source, and configured to reflect one of the two parts to the second wavelength conversion layer, and reflect the other of the two parts to the first wavelength conversion layer.

20. The light source module as claimed in claim 1, wherein the second light source further comprises a first reflective layer configured to reflect a part of the first light back to the first wavelength conversion layer.
